(19) United States
(12) Patent Application Publication
(10) Pub. No.: US 2008/0168850 A1
(43) Pub. Date: Jul. 17, 2008

(54) Display For Simultaneously Monitored Analytical Devices

(76) Inventor: Gregory T. Fischer, Glen Mills, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/622,975

(22) Filed: Jan. 12, 2007

(51) Int. Cl. B01L 11/00

(52) U.S. Cl. 73/866.3

(57) ABSTRACT

A display for monitoring a device group that includes at least one analytical device. The display has a primary section that shows device information for each analytical device in the device group. The device information has a plurality of information fields. A first visual element in the primary section corresponds to a filter action. The filter action filters the device information shown in the primary section based on a value in a chosen information field.

### BACKGROUND

Analytical devices are used to analyze biological and chemical substances. Analytical devices include, but are not limited to: gas chromatographs, liquid chromatographs, mass spectrometers, other chromatographic and spectrometry devices, and chromatographic and spectrometry accessories such as sample introduction and automation devices, trays, injector towers, pumps, auto-samplers, headspace samplers, etc. The analytical device can usually be controlled using a graphical user interface in a display that is located on the analytical device itself, or on a separate monitor of a computer that is in electronic communication with the analytical device.

Often, it is necessary to monitor multiple analytical devices at a time. For example, a laboratory commonly has several analytical devices in use at any given time. It may also be necessary to monitor multiple analytical devices across multiple laboratories at a time, as well. However, user interfaces in the past have lacked features that facilitate the monitoring of multiple analytical devices.

### BRIEF DESCRIPTION OF THE DRAWINGS

FIG. 1 illustrates an exemplary group of analytical devices in which the present invention may be practiced.

FIGS. 2A-C illustrate a user interface according to one embodiment.

FIG. 3 illustrates a user interface according to one embodiment.

### DETAILED DESCRIPTION

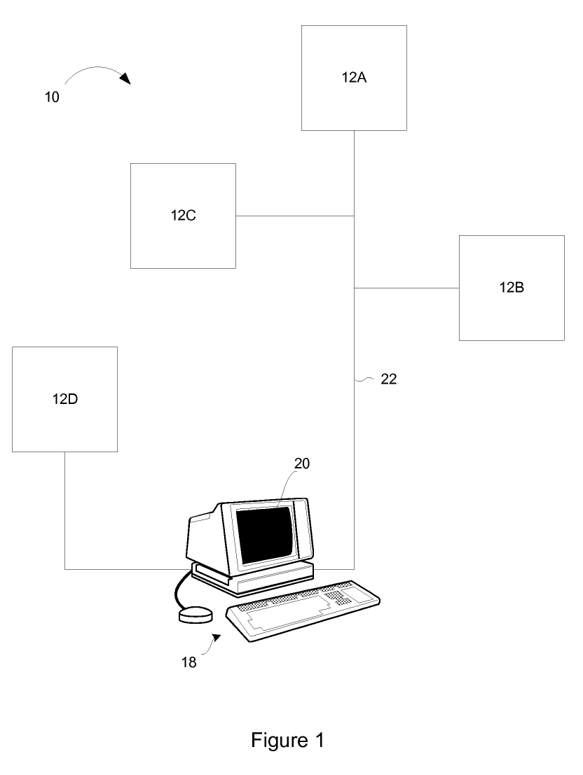

FIG. 1 illustrates an exemplary device group 10 of analytical devices in which the present invention may be practiced. The device group 10 includes at least one analytical device, and the word “group” as used in this application is defined to include a group having just a single analytical device. Analytical devices 12A-D are in electronic communication with a processing unit 18 having a display 20. The processing unit 18 in FIG. 1 is shown as a standalone computer, but can be any device having a processor and a corresponding display. For example, the processing unit can be another analytical device.

Each analytical device 12 communicates with the processing unit. In one embodiment, analytical devices 12A-D are connected to a network 22 to which the processing unit 18 is also connected. Exemplary networks 22 include (but are not limited to) local and wide area networks (LAN/WAN), wired and wireless networks, such as those based on Transmission Control Protocol/Internet Protocol (TCP/IP), General Purpose Interface Bus (GPIB, also referred to as standard number IEEE 488.1), RS232, and Universal Serial Bus (USB). The processing unit 18 may also be connected directly to the analytical devices it needs to monitor, as illustrated by the connection with analytical device 12D. Exemplary direct connections include (but are not limited to) those based on GPIB, RS232, and USB.

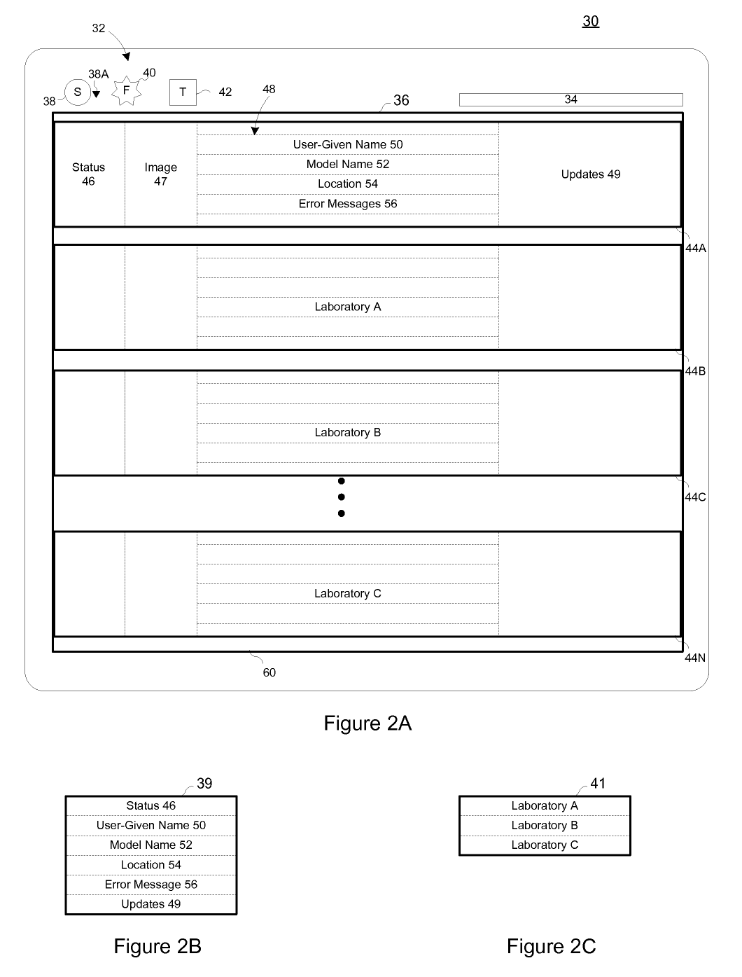

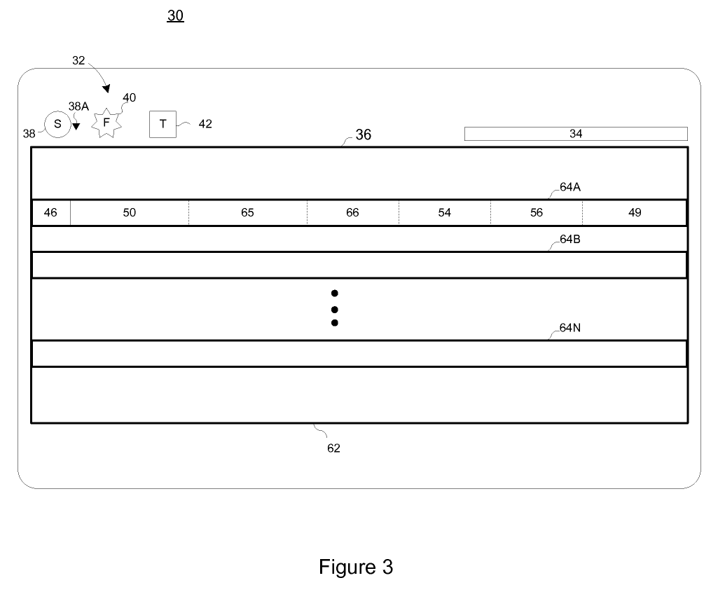

FIGS. 2A-C and 3 illustrate one embodiment of a user interface 30. The user interface 30 as shown in both FIGS. 2A and 3 has three main sections: an information window 36, a control section 32, and a monitored count section 34. The user interface 30 may be implemented using any programming language suitable for building graphical user interfaces. In an actual reduction to practice, the user interface was implemented using Microsoft's C-sharp (C-#, .NET 2.0) Other exemplary languages include (but are not limited to): Microsoft Managed C++ .NET, and Microsoft Visual Basic .NET.

### Information Window

The information window 36 is split into rows 44A-N, each row corresponding to a monitored analytical device. Within each row 44 are fields of information relating to the monitored analytical device. In one embodiment (as illustrated in FIG. 2), each row is divided into 4 columns of information. The first column is a status field 46, the second column is a device image field 47, the third column is a summary field 48, and the fourth column is an update field 49.

The status field 46 indicates the operational status of the analytical device, such as whether the device is functioning normally or if there is a problem with the device that needs to be fixed. In one embodiment, the status field 46 is a simple image representative of the operational status. When the analytical device is functioning normally, a normal status image should be displayed. When a problem exists, an error status image should be displayed. The error status image should contrast visually with the normal status image (e.g. different color, size, or shape) so that a user will be able to tell with a glance at the status field whether a problem exists. Examples of normal status images include, but are not limited to: a check mark, a green light, a green flag, thumbs-up image, etc. Examples of error status images include, but are not limited to: a cross-mark, a red light, a red flag, a thumbs-down image, etc. The image is a simple yet concise way of informing a user about the operational status of each analytical device. This is especially useful when multiple analytical devices are being monitored, since the user will be able to tell with a glance at the status field whether a problem exists.

The image field 47 is an image of the analytical device itself that is being monitored. In one embodiment, the image is an actual picture of the analytical device. Using the actual picture of the analytical device allows the user to quickly identify the device that is being monitored.

The summary field 48 is a descriptive summary of the monitored analytical device and includes 4 information fields: a user-given name 50, a model name 52, a location 54, and error messages 56.

The user-given name field 50 displays the user's preferred name for the analytical device being monitored. Similar to a nickname, this field allows the user to choose a name for the analytical device that is easier to remember than the actual model name of the device. For example, a user can enter “User Test Gas Chromatograph” in this field. This is simpler to remember than a manufacturer's model name that is often just a string of letters and numbers. This field also allows the user to easily differentiate between multiple analytical devices of the same model type.

The model name field 52 displays the manufacturer's model name and serial number for the monitored analytical device.

The location field 54 displays the physical location for the analytical device being monitored. For example, the user can enter “Laboratory Room 101” in this field. This allows the user to locate the analytical device quickly. This field is useful when problems crop up in a particular analytical device, and the user needs to locate the malfunctioning device for repair. This is also useful as a sort or filter control option, to be discussed in more detail below.

The error messages field 56 displays information regarding any errors or problems in the analytical device. If the analytical device is functioning normally, this field may be left blank, or a normal message can be displayed. However, if an error exists, this field will show an error message that contrasts visually with the normal message so that a user may see it more easily. For example, the error message can be in a contrasting font, color, or size from the normal message. Examples for differentiating the error message include, but are not limited to: using a bold font, using a color such as red or yellow, using a blinking font, and/or using a larger font.

The updates field 49 displays information regarding any updates in software, firmware, or documentation that may exist for the analytical device. This requires that the processing unit 18 be connected (e.g. via the network 22) to an information source (such as a central web server, computer, an update CD mailed periodically to the user, or other update delivery mechanism selected by the manufacturer of the analytical device) that provides information regarding such updates. If such a connection is not available, the updates field 49 may be left blank. This allows the user to retrieve updates for the analytical devices when they become available.

The information window 36 includes one row 44 for each analytical device being monitored, as indicated by rows 44A-N in FIG. 2. This layout and format allows the user to determine the status of multiple analytical devices with a quick glance at the information window 36.

### Control Section

The control section 32 consists of view altering elements 38-42 that change the information that the user sees in the information window 36. In one embodiment, view altering elements 38-42 are icons that represent actions that can be performed to change the information displayed in the information window 36 to the user's preference. These actions are triggered when a user selects the proper icon. In the figures, the icons used to represent view altering elements 38-42 are a circle, star, and a square, respectively; however, any icons may be used.

View altering element 38 represents a sort action, and shall hereinafter be referred to as the “Sort” button. The Sort button 38 includes a pull-down arrow 38A. When the pull-down arrow 38A is selected, a sort menu 39 is displayed (e.g. via a pull-down or pop-up menu) that allows the user to select which information field should be used in sorting the rows 44A-N. An exemplary sort menu 39 is shown in FIG. 2A. The options in the sort menu 39 are the different information fields that are displayed in the information window 36 such as those previously described above, with the exception of the image field 47.

When the Sort button 38 is selected, the rows 44A-N in the information window 36 are sorted into ascending order, by the information field selected in sort menu 39. The order used will differ depending on the type of data in the information field being sorted. For example, there can be ascending alphabetical order, ascending numerical order, ascending chronological order, ascending status order, etc. In one embodiment, the Sort button 38 is also a toggle button. Selecting the Sort button 38 will toggle the rows 44A-N between an ascending sort order and a descending sort order, based on the information field selected in sort menu 39. The icon used to represent Sort button 38 can also be toggled between different images to indicate the method currently being used (e.g. ascending vs. descending) to sort rows 44A-N. In one embodiment, the icon for Sort button 38 toggles between two images: an image with a down-arrow to indicate a descending sort; and an image with an up-arrow to indicate an ascending sort.

View altering element 40 represents a filter action, and shall hereinafter be referred to as the “Filter” button. When the Filter button 40 is selected, a filter menu 41 is displayed (e.g. via a pull-down or pop-up menu) that allows the user to select which information should be filtered. An exemplary filter menu 41 is shown in FIG. 3C. The options shown in the filter menu 31 will depend on what information field is selected in the sort menu 39. For example, suppose that the user selected the information field Location 54 in the sort menu 39. Then, a subsequent selection of the Filter button 40 would display the filter menu 41 listing the location fields for every monitored analytical device. A user must first select an information field from the sort menu 39 to populate the filter menu 31 with options, before the Filter button 40 can be used. In one embodiment, the icon for Filter button 40 is an image of a funnel.

The filter menu 41 shown in FIG. 3C is the result of previously selecting the Location field 54 in the sort menu 39. The options are the different location fields of the monitored analytical devices in the information window 36: Laboratory A, where the analytical device of row 44B is located; Laboratory B, where the analytical device of row 44C is located, and Laboratory C, where the analytical device of row 44N is located.

After an option is selected from the filter menu 41, the information window 36 is updated to display only the analytical devices with values that match the selected filter option. For example, if Laboratory A is selected from the filter menu 41 in FIG. 3C, then the information window 36 will change to display only the analytical device in row 44B.

View altering element 42 represents a toggle action, and shall hereinafter be referred to as the “Toggle” button. When the Toggle button 42 is selected, the information window 36 switches from picture mode to list mode, or vice versa. The information window 36 as shown in FIG. 2 and as described above is in picture mode 60. FIG. 3 shows the information window 36 in list mode 62. The list mode 62 will be described in greater detail below.

### Monitored Count Section

Returning to FIG. 2, the monitored count section 34 shows a count of how many devices are currently being displayed in the information window 36, and how many devices are being monitored in total. For example, the monitored count section 34 can display a message reading “Displaying 3 of N Monitored Instruments”. When no Sort or Filter option has been selected, the number of devices displayed should equal the number being monitored. However, if the user filters the information using the Filter button 40, some devices will no longer show up in the information window 36. The monitored count section 34 informs a user when only some of the monitored devices are being displayed in the information window 36.

### List Mode

FIG. 3 illustrates the information window 36 as it appears in list mode 62. As mentioned previously, the user can toggle the information window 36 between list mode 62 and picture mode 60 by selecting the Toggle button 42. In list mode, the information window 36 is split into rows 64A-N, each row corresponding to a monitored analytical device. In one embodiment, each row 64 is divided into 7 columns of information. The information in these columns has already been described previously for the picture mode 60 of the information window 36. However, the information is arranged differently in list mode 62 to give the user a different perspective on the status of the monitored analytical devices.

The first column contains the status field 46. In one embodiment, the status field 46 is a simple image representative of the operational status. The status field 46 has already been described in greater detail above.

The second column contains the user-given name field 50. The user-given name field 50 displays the user's preferred name for the analytical device being monitored. The user-given name field 50 has already been described in greater detail above.

The third column contains a model name field 65. The model name field 65 displays the manufacturer's model name for the monitored analytical device.

The fourth column contains a serial number field 66. The serial number field 66 displays the serial number of the monitored analytical device.

The fifth column contains the location field 54. The location field 54 displays the physical location for the analytical device being monitored. The location field 54 has already been described in greater detail above.

The sixth column contains the error messages field 56. The error messages field 56 displays information regarding any errors or problems in the analytical device. The error messages field 56 has already been described in greater detail above.

The seventh column contains the updates field 49. The updates field 49 displays information regarding any updates in software, firmware, or documentation that may exist for the analytical device. The updates field 49 has already been described in greater detail above.

In list mode 62, the information window 36 provides the user with a detailed summary of the analytical devices being monitored. Since there is no image field 47 in list mode 62, information about more analytical devices can be packed into a single window. The user can still use the Sort button 38 and Filter button 40 as before in picture mode 60 to change the order and number of analytical devices being shown in the information window 36.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A display for monitoring a device group including at least one analytical device, comprising:
a primary section that shows device information for each analytical device in the device group, the device information having a plurality of information fields; and
a first visual element that corresponds to a filter action that filters the device information shown in the primary section based on a value in a chosen information field.

2. A display as in claim 1, further comprising:
a second visual element that corresponds to a sort action that sorts the device information shown in the primary section into an order based on the chosen information field.

3. A display as in claim 2, wherein the second visual element further corresponds to a reverse sort action that reverses the order of device information shown in the primary section.

4. A display as in claim 1, wherein the plurality of information fields includes:
a status field that displays operational status for the analytical device.

5. A display as in claim 4, wherein the status field can display a normal status image, and an error status image that contrasts visually with the normal status image.

6. A display as in claim 1, wherein the plurality of information fields includes:
an error message field that displays any errors in the analytical device.

7. A display as in claim 6, wherein the error message field can display a normal message, and an error message that contrasts visually with the normal message.

8. A display as in claim 1, wherein the plurality of information fields includes:
a location field that displays a physical location for the analytical device.

9. A display as in claim 1, wherein the plurality of information fields includes:
a name field that displays a user-defined name for the analytical device.

10. A display as in claim 1, wherein the plurality of information fields includes:
an update field that displays any available updates for the analytical device.

11. A display as in claim 1, wherein the plurality of information fields includes:
a model name field that displays a model name for the analytical device.

12. A display as in claim 1, wherein:
the primary section includes a picture mode and a list mode, such that
the plurality of information fields in the picture mode includes an image field that contains an image of the analytical device; and
the plurality of information fields in the list mode lacks the image field.

13. A display as in claim 12, further comprising:
a third visual element that corresponds to a toggle action that toggles the primary section between the picture mode and the list mode.

14. A display as in claim 1, wherein the plurality of analytical devices is selected from the group consisting of gas chromatographs, liquid chromatographs, mass spectrometers, chromatographic devices, and spectrometric devices.

15. A display as in claim 1, further comprising:
a secondary section that displays
a first count of analytical devices shown in the primary section, and
a second count of analytical devices in the device group.

16. A system, comprising:
a device group, including at least one analytical device, the device group connected to a processing unit having a display, wherein the display includes:
a primary section that shows device information for each analytical device in the device group, the device information having a plurality of information fields; and
a first visual element that corresponds to a filter action that filters the device information shown in the primary section, based on a value in a chosen information field.

17. The system of claim 16, further comprising:
an information source connected to the processing unit that provides updates for an analytical device in the device group.

18. The system of claim 17, wherein the updates are selected from the group consisting of software, firmware, or documentation.

19. A method for monitoring a device group including at least one analytical device, comprising:
showing device information for each analytical device in the device group in a primary section, the device information having a plurality of information fields; and
filtering the device information shown in the primary section based on a value in a chosen information field.

20. A method as in claim 19, further comprising:
sorting the device information shown in the primary section into an order based on the chosen information field.
